(19) United States
(12) Patent Application Publication
(10) Pub. No.: US 2010/0226512 A1
(43) Pub. Date: Sep. 9, 2010

(54) PRESENTATION AUDIO SYSTEM

(75) Inventors: Kevin Sykes, Phoenix, AZ (US); Mitch Hensley, Maricopa, AZ (US); Dan Murphy, Glendale, AZ (US); Bruce Marlin, Ennis, TX (US)

Correspondence Address: KEITH L. JENKINS, Registered Patent Attorney, LLC, 44075 W. Neely Drive, Maricopa, AZ, 85138, US

(73) Assignee: MITEK CORP. INC., Phoenix, AZ (US)

(21) Appl. No.: 12/718,985

(22) Filed: Mar. 7, 2010

Related U.S. Application Data
(60) Provisional application No. 61/158,064, filed on Mar. 6, 2009.

(51) Int. Cl. H04R 3/00

(52) U.S. Cl. 381/111

(57) ABSTRACT

A presentation audio system with two dual-mode, dual-channel, wireless IR microphone/controllers that concurrently transmit multiplexed audio and command IR signals to IR sensors communicating to an amplifier that sends amplified audio to one or more speakers, responsive to the received commands. Each wireless IR microphone/controller includes a microphone and controller in a housing with manual controls and separate redundant groups of transmitting IR LEDs. The amplifier is controlled as to volume, audio sources selected, and control closure operation. First mode controls the audio of the IR microphone/controller that is set in the first mode and second mode controls all audio sources in the system. One manual control is a control closure that may be used to initiate a building alarm or for other purposes. A headset microphone jack enables use of the IR microphone/controller as an IR transmitter. A dual recharger usable vertically or horizontally is included.

### RELATIONSHIP TO OTHER APPLICATIONS

This application claims the benefit of provisional application Ser. No. 61/158,064 filed Mar. 6, 2009 naming the same inventors. Portions of the present disclosure relate to co-pending application Ser. No. 11/759,174 to the same owner, which is incorporated herein, in its entirety, by reference.

### BACKGROUND

This invention relates to Presentation Microphone Systems. More particularly, it relates to a classroom presentation systems. Yet more particularly it relates to a classroom presentation system including a wireless sound system with a microphone that is safely operable by students and teachers.

Modern classrooms are increasingly high-tech, with electronic audio presentation systems becoming the standard. A problem arises in providing students access to the classroom electronic audio systems without compromising system security and without enabling inappropriate prankster behavior over a broadcast audio system. A problem also exists in controlling the many amplifiers, receivers, and speakers, and other electronic components that are used in classroom electronic audio systems, primarily in the ease of control. Teachers must focus their attention on teaching, rather than on being electronic audio systems operators. Another problem has arisen in integrating classroom audio systems with classroom security systems. Space requirements for classroom audio systems pose another problem. Maintaining line-of sight between the transmitter on the teacher's microphone and a wireless receiver also presents problems. Radio-based systems tend to penetrate walls and interfere with neighboring classrooms.

Therefore, a need exists for a classroom audio system that centralizes control of the audio system in an easily accessible, conveniently wearable, electronic device. Further there is a need for a classroom audio system that enables student access to the audio system in a secure, controllable way. Another need is for a classroom audio system that integrates smoothly with classroom security systems. Yet another need is for a classroom audio system that has a minimum footprint on classroom space. Yet another need is for a teacher's microphone that always has a line of sight to a wireless receiver. The classroom audio system also needs to be economical, easy to use, convenient, and secure.

### OBJECTS AND FEATURES OF THE INVENTION

A primary object and feature of the present invention is to overcome the above-mentioned problems and fulfill the above-mentioned needs.

Another object and feature of the present invention is to provide a combined microphone and system controller that enables the user to access the audio system and control it from one small ergonomic device. Another object and feature of the present invention is to provide a wireless system that operates at a frequency that does not penetrate classroom walls. Another object and feature of the present invention is to provide a means for sending a distress signal to a building security system via the microphone/controller. Another object and feature of the present invention is to provide a presentation audio system with a minimal footprint in the classroom. Another object and feature of the present invention is to provide for integration of multiple audio sources, in addition to the audio input from the microphone/controller, that are controllable from the microphone/controller. Another object and feature of the present invention is to provide a microphone controller that is ergonomic and adaptable to various user preferences regarding carriage of the microphone/controller. Another object and feature of the present invention is to provide an audio system that is controlled by an IR remote control, wherein the IR remote control includes a microphone that provides IR-transmitted audio to the audio system. Another object and feature of the present invention is to provide a microphone controller that can be made safe for use by students. Another object and feature of the invention is transmission from the combined IR microphone/controller via multiple separate groups of redundant concurrently transmitting IR LEDs. Another object and feature of the invention is to enable use of the IR microphone/controller as an IR transmitter for use with a headset microphone. Another object and feature of the invention is to enable execution of a control closure from said IR microphone/controller through an amplifier. Another object and feature of the invention is to operate the IR microphone controller in various modes.

It is an additional primary object and feature of the present invention to provide such a system that is efficient, inexpensive and handy. Other objects and features of this invention will become apparent with reference to the following descriptions.

### SUMMARY OF THE INVENTION

In accordance with a preferred embodiment hereof, this invention provides IR microphone/controllers that combine a microphone and a controller in a single housing and are capable of multiplexing audio signals and controller commands and then transmitting the multiplexed signal, via multiple concurrently transmitting redundant groups of IR transmission LEDs, to a group of IR sensors. The IR sensors demultiplex the received IR signal into electronic audio and electronic command signals and supply those signals to an amplifier. The amplifier is controlled by the control signals as to amount of amplification, selection of signals to be amplified, and operation of a control closure. The amplifier may take in other audio signals from various sources, such as radio, TV/VCR, CD/DVD, computers, auxiliary sources such as digital cameras and a priority page input. The amplifier supplies amplified audio signals to one or more audio speakers. The system provides a recharging station that accepts two IR microphone/controllers at once. The recharger is operable in a vertical or horizontal orientation, and can conveniently fit on a bookshelf.

The microphone/controller is operable, in a first mode, to control only the volume of the signal from the microphone in the IR microphone/controller and in a second mode to control the volumes of signals from all audio input devices, except the priority age input. The IR microphone/controller has a switch in the battery compartment to lock out the ability to change any volumes at all. The microphone/controller may be worn on a particular lanyard using a key structure on the lanyard adjustment mechanism to fit into a key hole in the back of the IR microphone/controller. The lanyard has a safety break-away feature that reduces the risk of damage to the neck in an altercation. A spring-clip on the back of the IR microphone/controller may be used to attach the microphone/controller to clothing, such as a pocket or a belt. When carried thus remotely, an auxiliary headset microphone may be used, and the IR microphone/controller serves as an IR transmitter.

Thus, the invention provides a presentation audio system with two dual-mode, dual-channel, wireless IR microphone/controllers that concurrently transmit multiplexed audio and command IR signals to IR sensors communicating to an amplifier that sends amplified audio to one or more speakers, responsive to the received commands. Each wireless IR microphone/controller includes a microphone and controller in a housing with manual controls and separate redundant groups of transmitting IR LEDs. The amplifier is controlled as to volume, audio sources selected, and control closure operation. First mode controls the audio of the IR microphone/controller that is set in the first mode and second mode controls all audio sources in the system. One manual control is a control closure that may be used to initiate a building alarm or for other purposes. A headset microphone jack enables use of the IR microphone/controller as an IR transmitter. A dual recharger usable vertically or horizontally is included.

A presentation audio system including: an IR microphone/controller where the IR microphone of the IR microphone/controller is able to transduce sound into audio signals and the IR controller of the IR microphone/controller is able to transduce manual control manipulations into commands, and where the audio signals and the commands are multiplexed for wireless IR transmission from the IR microphone/controller; and multiple separate redundant groups of IR transmission LEDs able to concurrently wirelessly transmit the multiplexed audio signals and commands from the IR microphone/controller. The presentation audio system, including a control circuit closure responsive to a command from the IR microphone/controller to close a circuit that is not within the IR microphone/controller. The presentation audio system, including a group of devices for assisting in operating the IR microphone/controller while attached to one of the person of and the clothing of a user, the group of devices including; an ergonomically shaped housing for hand-held operation of the IR microphone controller as such; a spring clip rotationally coupled to the housing and biased to a closed position, for attachment to clothing of a user, and a microphone jack in the housing for connecting a headset microphone for operation of the IR microphone/controller as an IR transmitter; a keyhole in the spring clip and a lanyard for wearing about the neck of a user for supporting the IR microphone/controller for operation as such, including a spring-tensioned adjustment mechanism on the lanyard coupled to a key for coupling the lanyard to the keyhole. The presentation audio system, where the IR microphone controller is capable of operation in either a first mode or a second mode, where: the first mode enables volume control of the IR microphone/controller that is operated in the first mode when that IR microphone/controller is operated in the first mode; and the second mode enables volume control of the entire the audio presentation system from that IR microphone/controller when that IR microphone/controller is operated in the second mode. The presentation audio system, where the IR microphone/controller includes a group of visible-light LEDs mounted to a housing, including: a visible-light LED mounted partially exterior to the housing of the microphone controller able to illuminate to indicate that an ON/OFF switch has been switched to ON and able to blink to indicate a low battery condition; first and second mode indicator visible-light LEDs, including: the first mode visible-light indicator LED illuminatable to indicate first and second modes of operation; the second mode visible-light indicator LED illuminatable to indicate the second mode of operation; and both the first and second mode visible-light indicator LEDs not illuminatable responsive to a lock-out switch being activated, when the lock-out switch is activated; a third front-firing visible-light LED, illuminatable to indicate that the lock-out switch has been activated. The presentation audio system, including: an ergonomic housing enclosing the IR microphone/controller; a first group of the IR transmission LEDs of the multiple separate redundant groups of IR transmission LEDs, fixed proximate a bottom of the housing; a second group of the IR transmission LEDs of the multiple separate redundant groups of IR transmission LEDs, fixed proximate a top of the housing; and a third group of the IR transmission LEDs of the multiple separate redundant groups of the IR transmission LEDs, fixed proximate a front of the housing. The presentation audio system, where one of the groups of IR transmission LEDs of the multiple redundant groups of IR transmission LEDs is able to transmit in a 360 angular degree arc normal to a longitudinal axis of the housing. The presentation audio system, further including a group of IR sensors able to receive the multiplexed IR signals from the IR microphone/controller and to demultiplex the multiplexed IR signals from the IR microphone/controller into electronic audio signals and into electronic commands, respectively. The presentation audio system, including an amplifier able to: receive the electronic audio signals and electronic commands from the group of IR sensors; and house and operate, responsive to the received electronic commands, the control circuit closure. The presentation audio system, where the amplifier is further able to control amplification responsive to the received electronic commands; receive the electronic audio signals from a group of additional audio sources, and supply amplified audio signals to an audio speaker. The presentation audio system, where the amplifier is further able to be installed on an appliance support pole and able to be installed on an industry-standard electronics rack. The presentation audio system, including a group of additional audio sources able to supply audio signals to the amplifier. The presentation audio system, further including the audio speaker able to receive amplified audio signals from the amplifier. The presentation audio system, further including a recharging station able to recharge first and second IR microphone/controllers concurrently in one of a free-standing vertical orientation, a wall-mounted vertical orientation, and a horizontal orientation. The presentation audio system, where the IR microphone/controller further includes a group of manual controls that have differentiated tactility and are mounted proximate to and at least partially exterior to the housing, further including: a mode button that can toggle through the first and the second modes; a control closure button able to be manually depressed and, in conjunction with manual depression of the mode button, is able to send an IR command to initiate a control closure in an amplifier; a mute button, able in the first mode to mute the IR microphone while leaving the IR controller enabled; and able in the second mode to mute a second IR microphone in a second microphone/controller.

A presentation audio system including: an IR microphone/controller where the IR microphone of the IR microphone/controller is able to transduce sound into audio signals and the IR controller of the IR microphone/controller is able to transduce manual control manipulations into commands, where the audio signals and the commands are multiplexed for wireless IR transmission from the IR microphone/controller; multiple separate redundant groups of IR transmission LEDs able to concurrently wirelessly transmit the multiplexed audio signals and commands from the IR microphone/controller; and a control circuit closure responsive to a command from the IR microphone/controller to close a circuit that is not within the IR microphone/controller. The presentation audio system, including devices for assisting in operating the IR microphone/controller while attached to one of the person of and the clothing of a user, the devices including; an ergonomically shaped housing enabling hand-held operation of the IR microphone/controller as such; a spring clip coupled to the housing able to attach the IR microphone/controller to clothing of a user, and a microphone jack in the housing able to connect a headset microphone for operation of the IR microphone/controller as an IR transmitter; a keyhole in the spring clip and a lanyard for wearing about the neck of a user for supporting the IR microphone/controller for operation as such, the lanyard including a spring-tensioned adjustment mechanism coupled to a key able to couple the lanyard to the keyhole. The presentation audio system, where the IR microphone controller is capable of operation in either first mode or a second mode, where: the first mode enables volume control of an IR microphone/controller that is operated in the first mode when that IR microphone/controller is operated in the first mode; and the second mode enables volume control of the entire the audio presentation system from that IR microphone/controller when that IR microphone/controller is operated in the second mode.

A presentation audio system including: an IR microphone/controller where the IR microphone of the IR microphone/controller is able to transduce sound into audio signals and the IR controller of the IR microphone/controller is able to transduce manual control manipulations into commands, where the audio signals and the commands are multiplexed for wireless IR transmission from the IR microphone/controller; multiple separate redundant groups of IR transmission LEDs able to concurrently transmit the multiplexed audio signals and commands from the IR microphone/controller; a control circuit closure responsive to a command from the IR microphone/controller to close a circuit that is not within the IR microphone/controller; a group of devices for assisting in operating the IR microphone/controller while attached to either the person of or the clothing of a user, the group of devices including: an ergonomically shaped housing for hand-held operation of the IR microphone/controller as such; a spring clip rotationally coupled to the housing and biased to a closed position, for attachment to clothing of a user, and a microphone jack in the housing for connecting a headset microphone for operation of the IR microphone/controller as an IR transmitter; a keyhole in the spring clip and a lanyard for wearing about the neck of a user for supporting the IR microphone/controller for operation as such, including a spring-tensioned adjustment mechanism on the lanyard coupled to a key for coupling the lanyard to the keyhole; where the IR microphone controller is capable of operation in either of first and second modes, where: the first mode enables volume control of the particular IR microphone/controller that is in the first mode; and the second mode enables volume control of the entire the audio presentation system. The presentation audio system, including: a group of IR sensors able to receive the multiplexed IR signals from the IR microphone/controller and to demultiplex the multiplexed IR signals into electronic audio signals and into electronic commands, respectively; an amplifier, able to receive the electronic audio signals and the electronic commands from the group of IR sensors and further able to: house and operate, responsive to the received electronic commands, the control circuit closure; control amplification responsive to the received electronic commands; receive the electronic audio signals from a group of additional audio sources; supply amplified audio signals to a audio speaker; control amplification responsive to the received electronic commands; receive the electronic audio signals from a group of additional audio sources; supply amplified audio signals to an audio speaker; be installed on an appliance support pole; and be installed on an industry-standard electronics rack; and an audio speaker able to receive the amplified audio signals from the amplifier.

### BRIEF DESCRIPTION OF THE DRAWINGS

The above and other objects and advantages of the present invention will become more apparent from the following description taken in conjunction with the following drawings in which:

FIG. 1 is a block diagram illustrating an exemplary presentation audio system, according to a preferred embodiment of the present invention;

FIG. 2 is a flowchart illustrating the mode-change logic of the exemplary presentation audio system of FIG. 1, according to a preferred embodiment of the present invention;

FIG. 3 is a front elevation view, illustrating some features of an exemplary IR microphone/controller of the presentation audio system, according to the preferred embodiment of FIG. 1;

FIG. 4 is a left-angled elevational view, illustrating some features of an exemplary IR microphone/controller of the exemplary presentation audio system, according to the preferred embodiment of FIG. 1;

FIG. 5 is a right-angled elevational view, illustrating some features of an exemplary IR microphone/controller of the exemplary presentation audio system, according to the preferred embodiment of FIG. 1;

FIG. 6. is a right side elevational view, illustrating some features of an exemplary IR microphone/controller of the exemplary presentation audio system, according to the preferred embodiment of FIG. 1;

FIG. 7 is a rear elevational view, illustrating some features of an exemplary IR microphone/controller of the exemplary presentation audio system, according to the preferred embodiment of FIG. 1;

FIG. 8 is a left side elevational view, illustrating some features of an exemplary IR microphone/controller of the exemplary presentation audio system, according to the preferred embodiment of FIG. 1;

FIG. 9 is an exploded perspective view, illustrating some features of an exemplary IR microphone/controller of the exemplary presentation audio system, according to the preferred embodiment of FIG. 1;

FIG. 10 is a right-angled elevational view, illustrating an exemplary spring clip of the exemplary IR microphone/controller of the exemplary presentation audio system in an open position, according to the preferred embodiment of FIG. 1;

FIG. 11 is a right-angled elevational view, illustrating the exemplary spring clip of the exemplary IR microphone/controller of the exemplary presentation audio system in a closed position, according to the preferred embodiment of FIG. 1;

FIG. 12 is a front elevation view illustrating the exemplary IR microphone/controller of the exemplary presentation audio system of FIG. 1 being worn on an exemplary lanyard, according to the preferred embodiment of FIG. 1;

FIG. 13 is a perspective view illustrating the exemplary lanyard for the exemplary IR microphone/controller of the exemplary presentation audio system of FIG. 1, according to the preferred embodiment of FIG. 1;

FIG. 14 is a front elevation view illustrating two of the exemplary IR microphone/controllers of the exemplary presentation audio system of FIG. 1 in an exemplary recharging station, according to the preferred embodiment of FIG. 1;

FIG. 15 is a side elevation view illustrating two of the exemplary IR microphone/controllers of the exemplary presentation audio system of FIG. 1 in the exemplary recharging station, according to the preferred embodiment of FIG. 1 and FIG. 14;

FIG. 16 is a rear elevation view illustrating two of the exemplary IR microphone/controllers of the exemplary presentation audio system of FIG. 1 in the exemplary recharging station, according to the preferred embodiment of FIG. 1 and FIG. 14;

FIG. 17 is a perspective view illustrating two of the exemplary IR microphone/controllers of the exemplary presentation audio system of FIG. 1 in a horizontally-oriented exemplary recharging station, according to the preferred embodiment of FIG. 1 and FIG. 14;

FIG. 18 is a perspective view illustrating two of the exemplary IR microphone/controllers of the exemplary presentation audio system of FIG. I in a vertically-oriented exemplary recharging station, according to the preferred embodiment of FIG. 1 and FIG. 14;

FIG. 19 is a front perspective view illustrating an exemplary amplifier of the exemplary presentation audio system, according to the preferred embodiment of FIG. 1;

FIG. 20 is a rear perspective view illustrating the exemplary amplifier of the exemplary presentation audio system, according to the preferred embodiment of FIG. I and FIG. 19;

FIG. 21 is a front elevation view illustrating an exemplary side panel of the exemplary amplifier of the exemplary presentation audio system, according to the preferred embodiment of FIG. 1 and FIG. 19; and

FIG. 22 is a perspective view illustrating an exemplary pole adapter for the exemplary amplifier of the exemplary presentation audio system, according to the preferred embodiment of FIG. 1 and FIG. 19.

### DETAILED DESCRIPTION OF THE BEST MODES AND PREFERRED EMBODIMENTS OF THE INVENTION

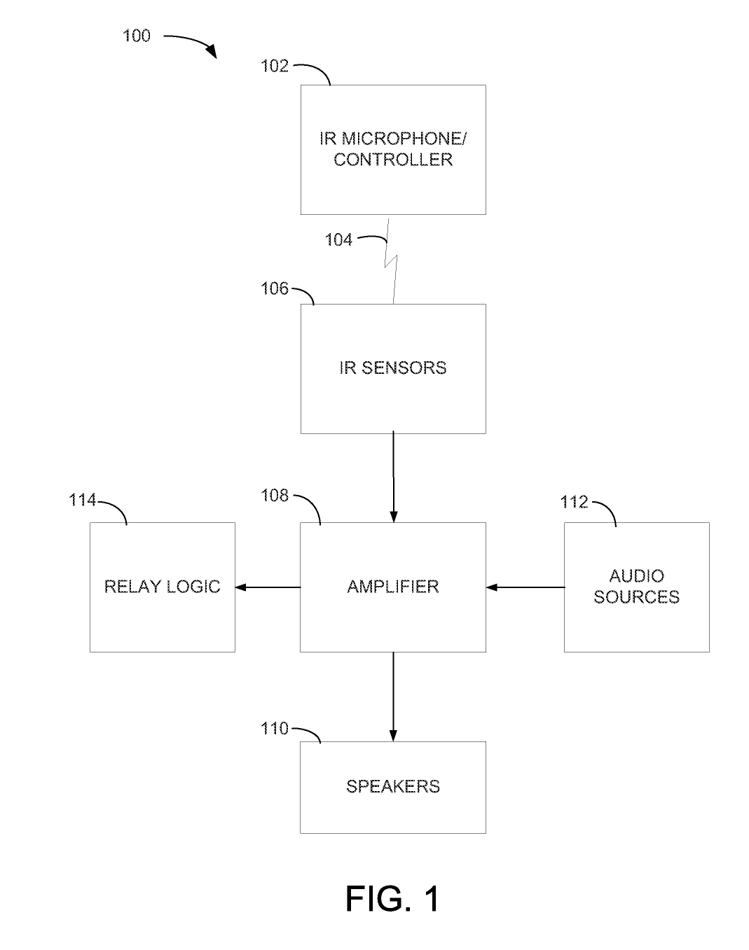

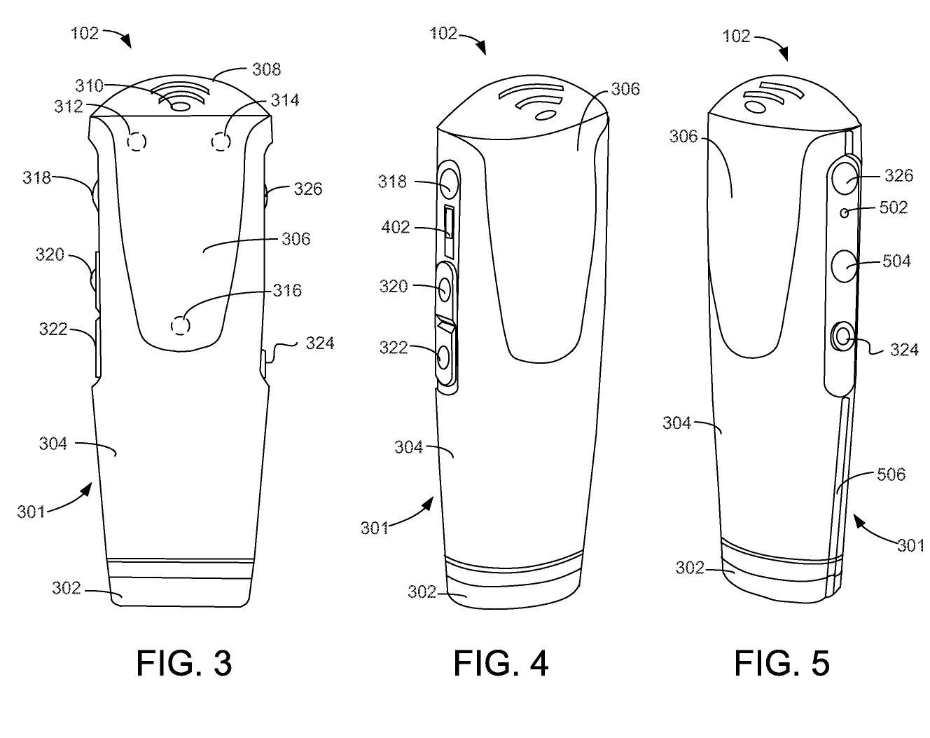

FIG. 1 is a block diagram illustrating a presentation audio system 100, according to a preferred embodiment of the present invention. IR microphone/controller 102 is defined as a combination IR microphone and IR controller in a common housing 301 (see FIG. 3). IR microphone/controller 102 sends multiplexed IR wireless audio signals and commands 104 to IR sensors 106 that are coupled to amplifier 108. The IR microphone transduces sound, such as voice, into audio signals and the IR controller transduces manual control manipulations into IR commands. IR sensors 106 demultiplex the IR audio and command signals 104 from IR microphone/controller 102 into electronic audio signals and electronic commands. Amplifier 108 receives the electronic audio signals from the IR sensors 106 and amplifies the electronic audio signals. Amplifier 108 receives the electronic commands from the IR sensors 106 and controls amplification, selection of audio sources 102, 112, and a control closure 2008 (see FIG. 20), responsive to the electronic commands. For example, the amplifier 108 may receive a command to increase amplification of audio from the IR microphone/controller 102, or to increase amplification of a various other audio signals such as those from various other audio sources 112. Amplifier 108 also receives signals from various other audio sources 112, such as, without limitation, radio, TV/VCR, CD/DVD, computers, and auxiliary sources such as digital cameras with sound. Amplifier 108 preferably provides amplified audio signals to at least one speaker 110, which may be configured in any known way, such as surround-sound, stereo, etc. Amplifier 108 is also operable to send execute control closure command, responsive to a control closure command from IR microphone/controller 102, to relay logic 114. For example, and without limitation, relay logic 114 may be a building alarm system used to alert security personnel to a problem in the classroom or other presentation venue. Relay logic target 114 is exemplary, and represents any relay-logic-operated subsystem, such as lighting, electronic door locks, firs suppression systems, etc. Speakers 110 are operable to receive amplified audio signals from amplifier 108 and may be arranged in any configuration, such as stereo, surround sound, and the like.

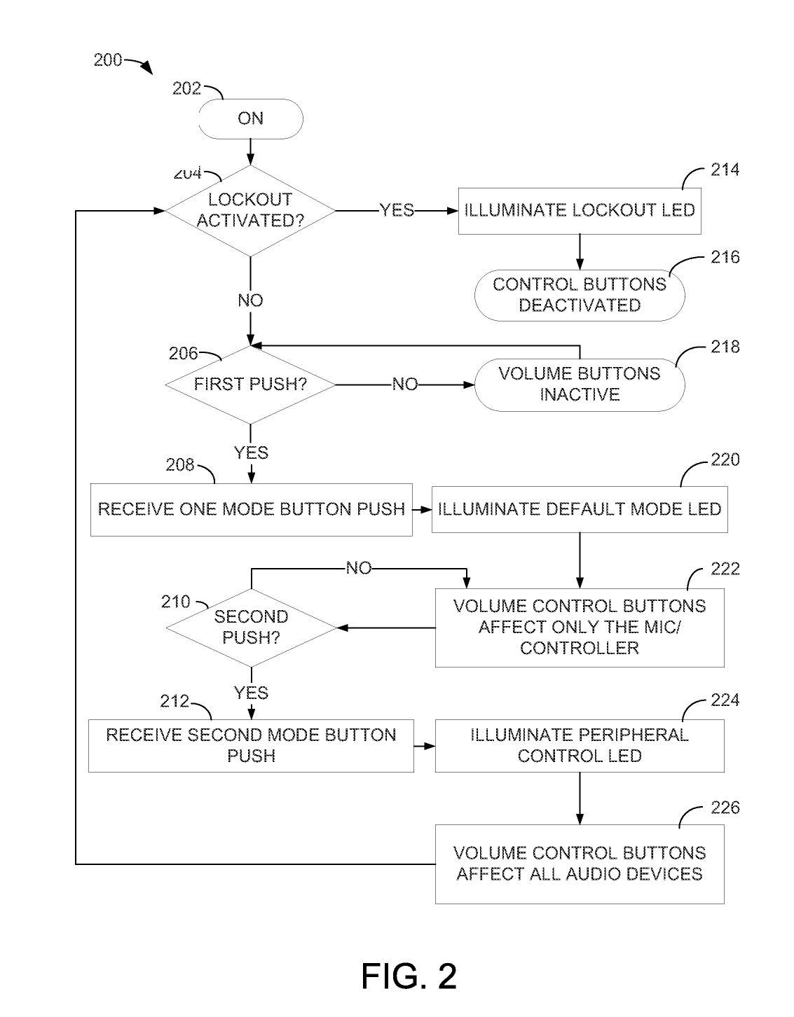

FIG. 2 is a flowchart illustrating the mode-change logic 200 of the exemplary presentation audio system 100 of FIG. 1, according to a preferred embodiment of the present invention. The presentation audio system 100 has first and second operational modes and, in addition, can be locked out. When the IR microphone/controller 102 is locked out, the manual controls 318, 320, 322, 326, and 504 do not operate. This is useful in a classroom setting, where students would be using the locked-out IR microphone/controller 102 and the teacher would be using a non-locked-out IR microphone/controller 102. In normal operation, first and second IR microphone/controllers are in concurrent use, each using a different IR channel, with a first IR microphone/controller 102 being in either first or second operational mode, as desired by a first user (such as a teacher, lecturer, presenter, etc.), and the second IR microphone/controller 102 locked out, thereby avoiding system 100 control conflicts from a second user (such as a student, audience member, etc.). First and second IR microphone/controllers 102 are of the same design.

The first operational mode is the default mode, in which the volume controls 320, 322 (see FIG. 3) affect audio from the IR microphone/controller 102 itself, and the second operational mode is the peripheral mode, in which the volume controls 320, 322 on the IR microphone controller 102 control the volume of all sources 102, 112 of sound coupled to or part of the system 100.

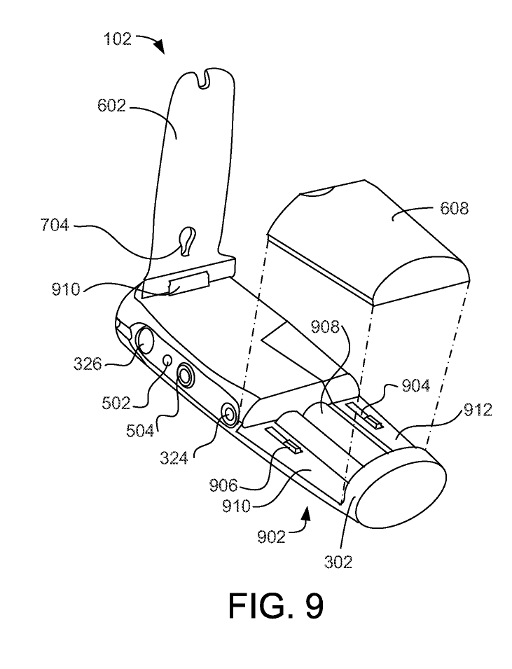

The IR microphone/controller 102 is turned on manually, using ON/OFF switch 402 (see FIG. 4) in step 202. Step 202 causes ON/OFF indicator light 502 (see FIG. 5) to illuminate. Step 204 determines if the lockout has been activated by use of lockout switch 904 (see FIG. 9). If so, step 214 illuminates the lockout LED indicator 316 (see FIG. 3) and step 214 also deactivates the volume control buttons 320, 322, the mode button 318, the mute button 504, and the control closure button 326 on IR microphone/controller 102. Steps 214 and 216 may be implemented in software, hardware, or firmware. If step 204 determines that the lockout switch 904 is not activated, step 206 determines if the mode button 318 has received a first push. If not, the volume buttons 320, 322 remain inactive, as shown under step 218, until the mode button 318 has been pushed. If mode button 318 has been pressed once, an indication is received in step 208 and the default mode visible-light LED indicator 312 is illuminated in step 220. In step 222, after a single push of mode button 318, the volume control buttons 320, 322, affect only the audio signal from the IR microphone/controller 102 that is in default mode. Step 210 determines if the mode button 318 has been pushed twice. If not, the mode remains the default mode and the status created by step 222 remains. If a second push is determined 210 to have occurred, an indicator of the second push is received in step 212 and the peripheral control mode visible-light LED indicator 314 illuminates in step 224. In step 226, the volume control buttons 320, 322 control the audio volume for the entire presentation audio system 100, such as audio signals from audio sources 112 and from a second locked-out IR microphone/controller 102. If the mode control button 318 is pressed a third time, the mode toggles around to first (default) mode, etc.

FIG. 3 is a front elevation view, illustrating some features of an exemplary IR microphone/controller 102 of the exemplary presentation audio system 100, according to the preferred embodiment of FIG. 1. IR microphone/controller 102 is designed as a hand-held microphone and audio controller. Ergonomic housing 301 preferably includes a plurality of shaped exterior panels 302, 304, 306, 308, of hard plastic with good wear characteristics. Housing 301 is ergonomic by virtue of its size and shape and because of the placement of manual controls 318, 320, 322, 326, 402, and 504. Base 302 encloses a group of IR LEDs for transmitting multiplexed audio signals and commands 104 to IR sensors 106. The base group of IR LEDs are arranged in a pattern to transmit IR in a 360° angular arc, generally normal to the longitudinal axis of housing 301. Base 302 is an exterior panel of housing 301 and is preferably made of a material that is transparent to at least two IR frequencies (corresponding to two channels of IR) and is not fully transparent in the visible, such as darkened translucent plastics known in the art. Body 304 is at least one exterior panel of housing 301. Window 306 is an exterior panel of housing 301 made of similar material to base 302 but also transmissible in at least two visible-light frequencies. In addition to the default mode visible-light LED indicator 312, peripheral control mode visible-light LED indicator 314, and visible-light LED lockout mode indicator 316, window 306 encloses a group of forward-signaling IR LEDs (not shown) that concurrently and redundantly (with the top and bottom IR LED groups) transmit multiplexed signals 104 to the IR sensors 106. Top piece 308 is also an exterior panel of housing 301 that is an IR transparent window (in at least two IR channels) covering another separate group of redundant concurrently transmitting top-mounted signaling 104 IR LEDs (not shown) and partially enclosing a microphone 310.

Mode button 318 is convex, and volume increase button 320 has a convex portion on a platform for easy tactile identification. Volume decrease button 322 has a concave portion on a platform, to make it tactilely distinguishable from the volume increase button 320. Control closure button 326 is on the right side of the microphone/controller 102, and opposed in alignment to mode button 318. If both the control closure button 326 and the mode button 318 are pressed concurrently for a predetermined amount of time, as by squeezing, a control closure signal is sent as a multiplexed command 104 to the IR sensors 106 and then to the amplifier 108. In a particular installed embodiment, relay logic 114 may be a building alarm system. A microphone jack 324 is provided for instances where the user is more comfortable with a headset microphone jacked in to the microphone/controller, with the IR microphone/controller 102 in a pocket or clipped onto a belt or pocket, and acting as an IR transmitter. By providing manual controls 318, 320, 322, 326, 402, and 504 that exhibit differentiated tactility, the controls 318, 320, 322, 326, 402, and 504 can be operated by touch and without the user having to view them. Manual controls 318, 320, 322, 326, 402, and 504 extend though the at least one exterior panel 304. Manual controls 318, 320, 322, 326, 402, and 504 may be mounted on exterior panels 302, 304, 306, 308 of housing 301 or may be mounted on interior panels (not shown) proximate said exterior panels 302, 304, 306, 308 and may extend through exterior panels 302, 304, 306, 308 of housing 301.

FIG. 4 is a left-angled elevational view, illustrating some features of an exemplary IR microphone/controller 102 of the presentation audio system 100, according to the preferred embodiment of FIG. 1. ON/OFF button 402 is a slider switch, and provides tactile differentiation between the convex mode switch 318 and the convex portion of volume switch 320.

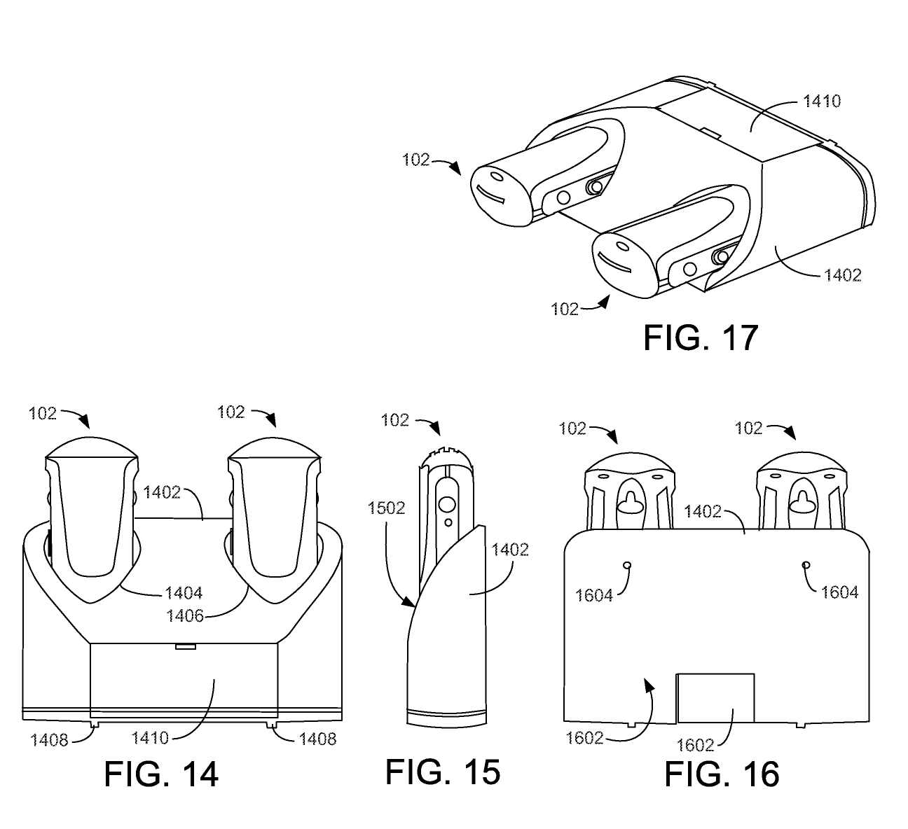

FIG. 5 is a right-angled elevational view, illustrating some features of an exemplary IR microphone/controller 102 of the exemplary presentation audio system 100, according to the preferred embodiment of FIG. 1. Exemplary ON/OFF indicator light 502 is a visible-light LED that protrudes through an external panel 304 of the housing 301 of the IR microphone/controller 102 and illuminates when the ON/OFF switch 402 is switched to ON. Indicator light 502 blinks to indicate a low battery condition. Mute button 504 is a toggle switch, allowing the user to mute the audio from the IR microphone/controller 102 in default mode and to mute the peripheral devices 110, 112 and a locked out second IR microphone/controller 102 in peripheral mode. Alignment rib 506 aligns the IR microphone/controller 102 in the recharging station 1402 (see FIG. 14) for recharging.

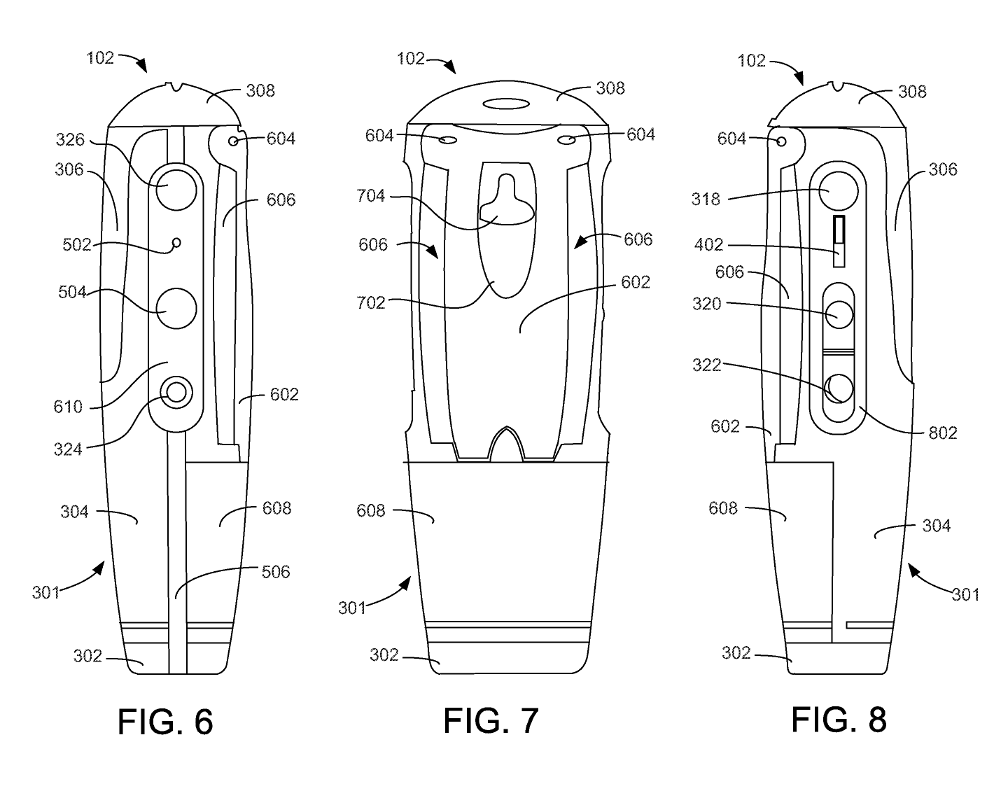

FIG. 6 is a right side elevational view, illustrating some features of an exemplary IR microphone/controller 102 of the exemplary presentation audio system 100, according to the preferred embodiment of FIG. I. Spring clip 602 is rotationally coupled to housing 301 by a hinged pivot 604, is shown in the closed position. Spring clip 602 is ergonomically conformal to housing 301. Tactile access port 606 is a gap between the spring clip 602 and the rear portion of housing 301. Tactile access port 606 makes it easy to open the spring clip 602 with the fingers. Snap-closable battery compartment cover 608 is an exterior panel of housing 301 and is removable for access to the battery compartment 902 (See FIG. 9). Manual controls 326 and 504, as well as microphone jack 324 and power indicator LED 502 emerge from right-hand side flat portion 610 of housing 301.

FIG. 7 is a rear elevational view, illustrating some features of an exemplary IR microphone/controller 102 of the exemplary presentation audio system 100, according to the preferred embodiment of FIG. 1. Spring clip 602 has a keyhole 704 for attaching a safety lanyard 1202. Détente 702 in spring clip 602 aids in guiding key 1306 (see FIG. 13) into keyhole 704 for coupling the IR microphone/controller 102 to the lanyard 1202.

FIG. 8 is a left side elevational view, illustrating some features of an exemplary IR microphone/controller 102 of the exemplary presentation audio system 100, according to the preferred embodiment of FIG. 1. Manual controls 318, 320, 322, and 402 extend from left-hand side flat portion 802 of housing 301. The profile shape of the IR microphone/controller 102 is ergonomic for hand held use.

FIG. 9 is an exploded perspective view, illustrating some features of an exemplary IR microphone/controller 102 of the exemplary presentation audio system 100, according to the preferred embodiment of FIG. 1. Battery compartment 902 contains channel switch 906, which protrudes from inner panel 910. Channel switch 906 is a two-position slider switch for selecting either channel A or channel B for IR transmission. Lockout switch 904, which protrudes from inner panel 912, is a two-position slider switch for either locking out system controls such as volume controls 320 and 322 and mode switch 318, or enabling such controls. In a classroom setting, the lockout switch 904 might be used when passing an IR microphone/controller 102 among students, to reduce pranks with the system controls. In preferred usage, a first IR microphone controller 102 operating on a first IR channel would be used by the presenter (teacher, lecturer, etc.), and a second IR microphone/controller 102 operating on a second IR channel would be used by a presentee (member of the audience, student, etc.).

Batteries 908 are rechargeable and preferably removable. Spring clip 602 has a biasing mechanism 910 for biasing the spring clip 606 closed, and a support, not shown, for holding it open when opened fully, as shown.

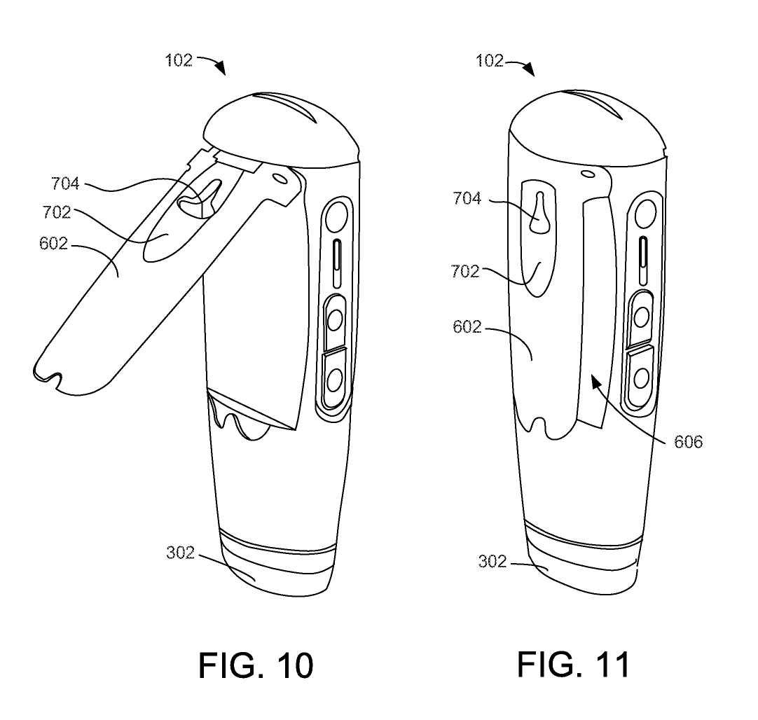

FIG. 10 is a right-angled elevational view, illustrating the spring clip 602 of the microphone/controller 102 of the exemplary presentation audio system 100 in an open position, according to the preferred embodiment of FIG. 1. Spring clip 602 may be used to clip the IR microphone/controller 102 to a user's belt, pocket edge (pant or shirt pocket), or other clothing or wearable device. When used with a headset microphone plugged into microphone jack 324, the clipped on IR microphone/controller 102 functions as an IR transmitter, as the integral microphone 310 is disabled during use of the microphone jack 324. FIG. 10 is provided for contrast with FIG. 11.

FIG. 11 is a right-angled elevational view, illustrating the spring clip 602 of the microphone/controller 102 of the exemplary presentation audio system 100 in a closed position, according to the preferred embodiment of FIG. 1. Finger gap 606 is another ergonomic feature of the IR microphone/controller 102. Compare to FIG. 10.

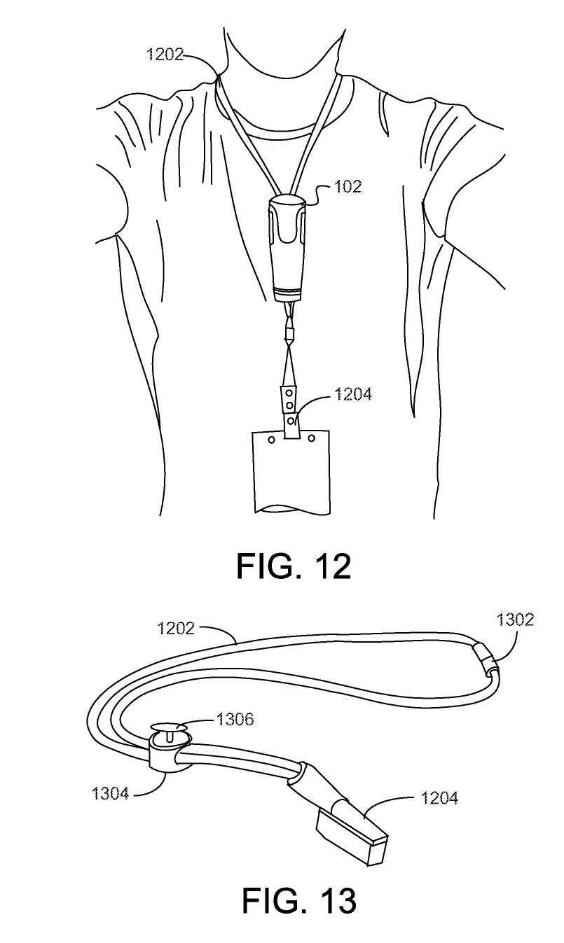

FIG. 12 is a front elevation view illustrating the exemplary IR microphone/controller 102 of the exemplary presentation audio system 100 of FIG. 1 being worn on a lanyard 1202, according to the preferred embodiment. FIG. 12 illustrates one method of carriage for the IR microphone/controller 102. Lanyard 1202 is worn about the neck with the IR microphone/controller 102 attached and adjusted to bring the microphone into operationally useful proximity with the user's mouth. The lanyard 1202 includes a clip 1204 for holding credentials and the like. Other methods of carriage include using the spring clip 602 to attach the IR microphone/controller 102 to a belt, or to a pocket or other clothing edge, while using an auxiliary microphone (not shown) via microphone jack 324. Yet another method of carriage for the IR microphone/controller 102 is to simply carry it in a shirt pocket.

FIG. 13 is a perspective view illustrating the lanyard 1202 for the exemplary IR microphone/controller 102 of the exemplary presentation audio system 100 of FIG. 1, according to the preferred embodiment. Lanyard 1202 has a spring-tensioned adjustment mechanism 1304, with an attached key 1306 which fits and is operable to be secured in keyhole 704 in order to couple the lanyard 1202 to the IR microphone/controller 102. Safety break-away coupling 1302 separates the lanyard 1202 when more than a predetermined amount of tension is present. The predetermined amount of tension is determined based on user safety.

FIG. 14 is a front elevation view illustrating two of the exemplary IR microphone/controllers 102 of the exemplary presentation audio system 100 of FIG. 1 in an exemplary recharging station 1402, according to the preferred embodiment of FIG. 1. Recharging station 1402 is shown in a free-standing vertical orientation. Recharging station 1402 has two openings 1404, 1406, each adapted to recharge one IR microphone/controller 102. Openings 1404 and 1406 feature grooves (not shown) that are complimentary to the ribs 506 on the IR microphone/controllers 102 to assist in proper alignment of the IR microphone/controllers 102 in recharging station 1402. Compartment door 1410 provides access to the inner electronics of the recharging circuitry. For cooling purposes, the recharging station 1402 has feet 1408 that provide air circulation under the charger 1402. Charging circuitry, as is known in the art, is inside the recharging station 1402.

FIG. 15 is a side elevation view illustrating two of the exemplary IR microphone/controllers 102 of the exemplary presentation audio system 100 of FIG. 1 in a recharging station 1402, according to preferred embodiment of FIG. 1 and FIG. 14. Recharging station 1402 is shown in a free-standing vertical orientation. Top surface 1502 is curved to balance ergonomic considerations with an alternative horizontally-oriented operation of the recharging station 1402.

FIG. 16 is a rear elevation view illustrating two of the exemplary IR microphone/controllers 102 of the exemplary presentation audio system 100 of FIG. 1 in an exemplary recharging station 1402, according to the preferred embodiment of FIG. 1 and FIG. 14. Recharging access door 1602 covers the access port used for recharging from a wall socket, as will be discussed further below. Holes 1604 are for optionally wall-mounting the recharging station 1402 in a vertical orientation. Rear surface 1602 may have feet (not shown).

FIG. 17 is a perspective view illustrating two of the exemplary IR microphone/controllers 102 of the exemplary presentation audio system 100 of FIG. 1 in an exemplary horizontally-oriented recharging station 1402, according to the present embodiment. The ability of the charging station 1402 to operate horizontally enables the user to place the charging station 1402 in narrow spaces, such as shelves, that would be unavailable in the vertical orientation.

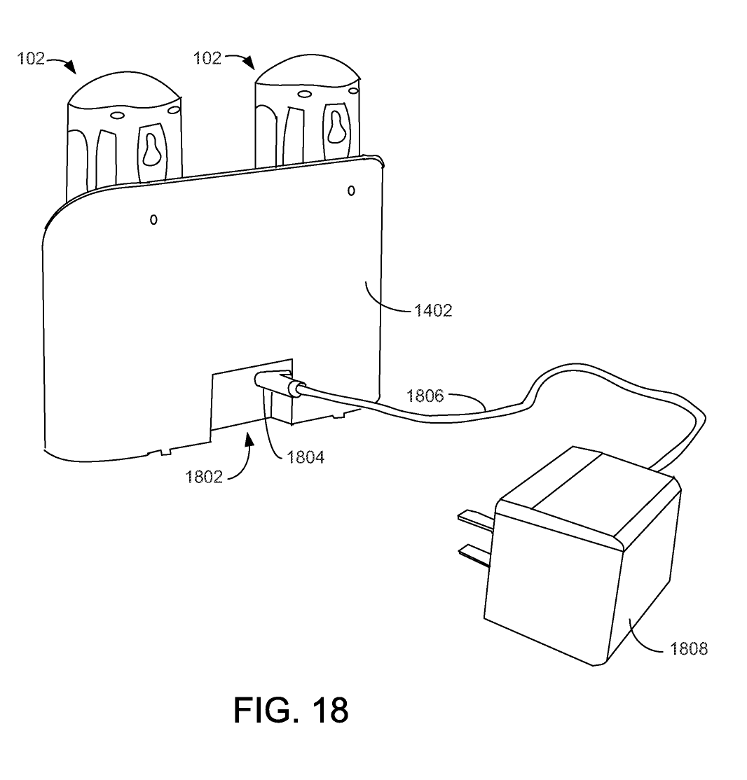

FIG. 18 is a perspective view illustrating two of the exemplary IR microphone/controllers 102 of the exemplary presentation audio system 100 of FIG. 1 in an exemplary vertically-oriented recharging station 1402, according to the present embodiment. Recharging access door 1602 has been removed to show access cavity 1802 that contains a power receptacle. Power plug 1804 is shown plugged into the power receptacle. By rotating the power plug clockwise 90°, the power plug 1804 can be moved into position for charging when the recharging station 1402 is horizontal, as shown in FIG. 17. Power plug 1804 is radially symmetrical in its electrical connector. Cord 1806 couples power plug 1804 to transformer 1808 that is operable to provide recharging power from household line voltage.

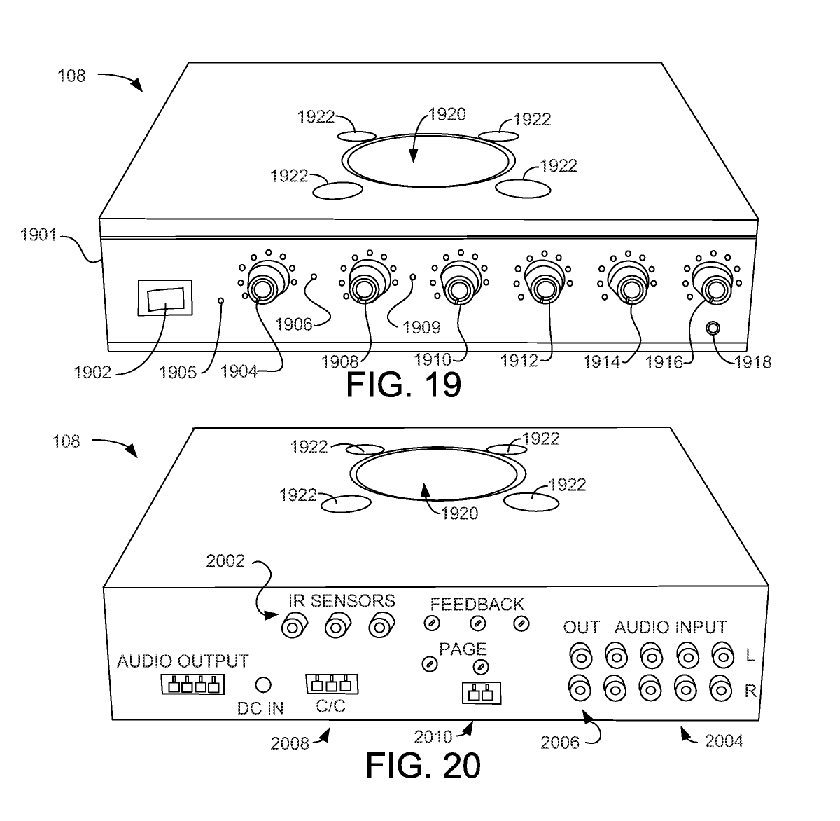

FIG. 19 is a front perspective view illustrating an exemplary amplifier 108 of the exemplary presentation audio system 100, according to the preferred embodiment of FIG. 1. The chassis 1901 of amplifier 108 is adapted to be pole-mounted on a pole, such as an appliance mounting pole, that goes completely through opening 1920 or, alternatively, to be rack-mounted, as taught in co-pending application Ser. No. 11/759,174 to the same owner. Countersinks 1922 may receive screws to assist in securing the pole-mounted chassis 1901 to a pole. By pole-mounting on a pole from the ceiling, significant space is saved and theft risk is reduced. Amplifier ON/OFF switch 1902 is a rocker switch. LED 1905 illuminates when power is on. Dial 1904 controls channel A, and LED 1908 indicates when channel A is active. Dial 1908 controls channel B, and LED 1909 indicates when channel B is active. Dials 1920, 1912, 1914, and 1916 control other audio sources 112, as previously mentioned. Jack 1918 is an auxiliary input jack.

FIG. 20 is a rear perspective view illustrating an exemplary amplifier 108 of the exemplary presentation audio system 100, according to the preferred embodiment of FIG. 1. IR sensor input jacks 2002 are the points on the amplifier 108 where the IR sensor 106 inputs are received at the amplifier 108. Other audio sources 112 have input jacks 2004 (four pairs illustrated). There is a line out for recording or other purposes at 2006. Control closure couplings are received at control closure jack 2008. Control closure jack 2008 has three couplings for wires. One coupling is for a ground wire from an external relay logic 114. A second coupling is for a wire from a “normally closed” external relay contact in relay logic 114, and a third coupling is for a “normally open” relay contact in relay logic 114. When the control closure button 326 and the mode button 318 are pressed at the same time, a command is generated and transmitted that results in the control closure jack 2008 being energized to change the state of relay logic 114. The energized relay logic 114 may then activate an alarm, lock an electronic lock, turn off the room lighting, or perform any other function that can be done with a relay logic 114 used as an on/off switch. Relay logic 114 may be complex, as where the activation of a single relay activates, in turn a plurality of other relays that may variously turn other subsystems on or off. In a particular embodiment, the relay 114 activates a building alarm system, which alarm system is part of the presentation audio system 100.

Page input 2010 receives a priority page, in the form of audio signals, from an outside source, such as a school public address or alarm system. Audio signals received at the priority page input 2010 are amplified and sent to all audio speakers 110 to the exclusion of all other amplified audio signals in the presentation audio system 100.

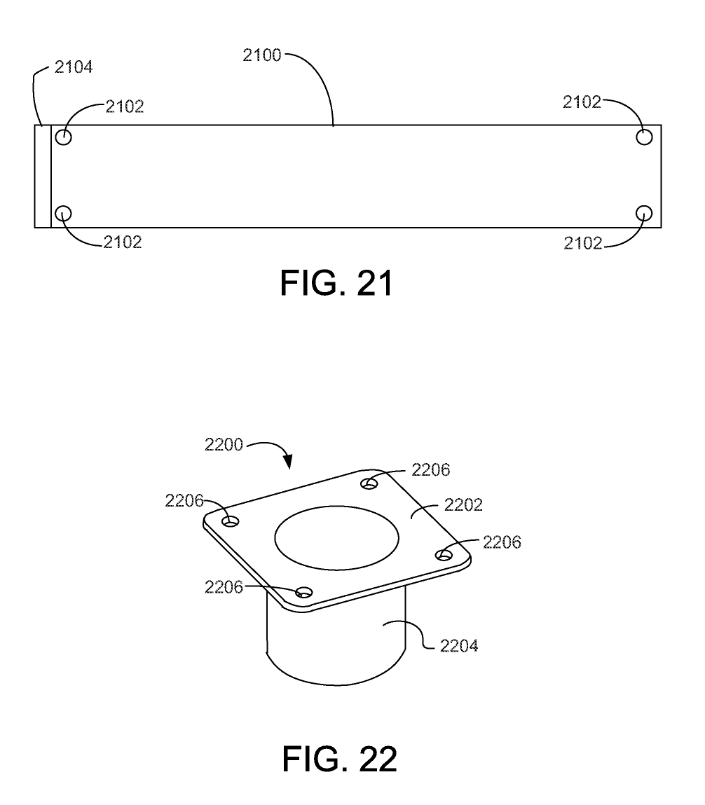

FIG. 21 is a front elevation view illustrating an exemplary side panel 2100 of the exemplary amplifier 108 of the exemplary presentation audio system 100, according to the preferred embodiment of FIG. 1. The side panel 2100 has holes 2102 for receiving fasteners for rack mounting. Additionally, the side panel 2100 is sized and shaped adaptably to one of various standard electronic racks. Standard electronic racks are known in the art as vertical arrays of receivers for electronic modules, such as amplifier 108. Standard electronics racks receive electronic modules of particular sizes and shapes, and with particular fastener adaptations 2102. A removable front panel 2104 is provided.

FIG. 22 is a perspective view illustrating an exemplary pole adapter 2200 for the exemplary amplifier 108 of the exemplary presentation audio system 100, according to the preferred embodiment of FIG. 1. The pole adapter 2200 includes a cylindrical web 2204 and a flange 2202. Holes 2206 align with countersinks 1922 when the cylindrical web 2204 is inserted into opening 1920. The inside cross-section of cylindrical web 2204 is sized and shaped to slidingly receive an appliance mounting pole. Clamping means, not shown, are also employed.

We claim:

1. A presentation audio system comprising:
a. at least one IR microphone/controller wherein said IR microphone of said at least one IR microphone/controller is operable to transduce sound into audio signals and said IR controller of said at least one IR microphone/controller is operable to transduce manual control manipulations into commands, and wherein said audio signals and said commands are multiplexed for wireless IR transmission from said at least one IR microphone/controller; and
b. multiple separate redundant pluralities of IR transmission LEDs operable to concurrently wirelessly transmit said multiplexed audio signals and commands from said at least one IR microphone/controller.

2. The presentation audio system of claim 1, comprising a control circuit closure responsive to a command from said at least one IR microphone/controller to close a circuit that is not within said at least one IR microphone/controller.

3. The presentation audio system of claim 1, comprising a plurality of devices for assisting in operating said at least one IR microphone/controller while attached to one of the person of and the clothing of a user, said plurality of devices comprising;
a. an ergonomically shaped housing for hand-held operation of said at least one IR microphone controller as such;
b. a spring clip rotationally coupled to said housing and biased to a closed position, for attachment to clothing of a user, and a microphone jack in said housing for connecting a headset microphone for operation of said IR microphone/controller as an IR transmitter;
c. a keyhole in said spring clip and a lanyard for wearing about the neck of a user for supporting said at least one IR microphone/controller for operation as such, comprising a spring-tensioned adjustment mechanism on said lanyard coupled to a key for coupling said lanyard to said keyhole.

4. The presentation audio system of claim 1, wherein said at least one IR microphone controller is capable of operation in one of a first mode and a second mode, wherein:
a. said first mode enables volume control of a particular IR microphone/controller that is operated in said first mode when said particular IR microphone/controller is operated in said first mode; and
b. said second mode enables volume control of the entire said audio presentation system from said particular IR microphone/controller when said particular IR microphone/controller is operated in said second mode.

5. The presentation audio system of claim 4, wherein said IR microphone/controller further comprises a plurality of visible-light LEDs mounted to a housing, including:
a. a visible-light LED mounted partially exterior to said housing of said at least one IR microphone/controller operable to illuminate to indicate that an ON/OFF switch has been switched to ON and operable to blink to indicate a low battery condition;
b. first and second mode indicator visible-light LEDs, comprising:
i. said first mode visible-light indicator LED illuminatable to indicate first and second modes of operation;
ii. said second mode visible-light indicator LED illuminatable to indicate said second mode of operation; and
iii. both said first and second mode visible-light indicator LEDs not illuminatable responsive to a lock-out switch being activated, when said lock-out switch is activated;
c. a third front-firing visible-light LED, illuminatable to indicate that said lock-out switch has been activated.

6. The presentation audio system of claim 1, comprising:
a. an ergonomic housing enclosing said at least one IR microphone/controller;
b. a first plurality of said IR transmission LEDs of said multiple separate redundant pluralities of IR transmission LEDs, fixed proximate a bottom of said housing;
c. a second plurality of said IR transmission LEDs of said multiple separate redundant pluralities of IR transmission LEDs, fixed proximate a top of said housing; and
d. a third plurality of said IR transmission LEDs of said multiple separate redundant pluralities of said IR transmission LEDs, fixed proximate a front of said housing.

7. The presentation audio system of claim 6, wherein one said plurality of IR transmission LEDs of said multiple redundant pluralities of IR transmission LEDs is operable to transmit in a 360 angular degree arc normal to a longitudinal axis of said housing.

8. The presentation audio system of claim 1, further comprising a plurality of IR sensors operable to receive said multiplexed IR signals from said at least one IR microphone/controller and to demultiplex said multiplexed IR signals from said at least one IR microphone/controller into electronic audio signals and into electronic commands, respectively.

9. The presentation audio system of claim 1, comprising at least one amplifier operable to:
a. receive said electronic audio signals and electronic commands from said plurality of IR sensors; and
b. house and operate, responsive to said received electronic commands, said control circuit closure.

10. The presentation audio system of claim 9, wherein said amplifier is further operable to:
a. control amplification responsive to said received electronic commands;
b. receive said electronic audio signals from a plurality of additional audio sources; and
c. supply amplified audio signals to at least one audio speaker.

11. The presentation audio system of claim 9, wherein said amplifier is further operable to:
a. be installed on an appliance support pole; and
b. be installed on an industry-standard electronics rack.

12. The presentation audio system of claim 9, comprising a plurality of additional audio sources operable to supply audio signals to said amplifier.

13. The presentation audio system of claim 1, further comprising said at least one audio speaker operable to receive amplified audio signals from said amplifier.

14. The presentation audio system of claim 1, further comprising a recharging station operable to recharge first and second said IR microphone/controllers concurrently in one of a free-standing vertical orientation, a wall-mounted vertical orientation, and a horizontal orientation.

15. The presentation audio system of claim 1, wherein said at least one IR microphone/controller further comprises a plurality of manual controls that have differentiated tactility and are mounted proximate to and at least partially exterior to said housing, further comprising:
a. a mode button operable as a toggle through said first and said second modes;
b. a control closure button operable to be manually depressed and, in conjunction with manual depression of said mode button, is operable to send an IR command to initiate a control closure in an amplifier;
c. a mute button, operable:
i. in said first mode to mute said at least one IR microphone while leaving said IR controller enabled; and
ii. in said second mode to mute a second IR microphone in a second said at least one microphone/controller.

16. A presentation audio system comprising:
a. at least one IR microphone/controller wherein said IR microphone of said at least one IR microphone/controller is operable to transduce sound into audio signals and said IR controller of said at least one IR microphone/controller is operable to transduce manual control manipulations into commands, wherein said audio signals and said commands are multiplexed for wireless IR transmission from said at least one IR microphone/controller;
b. multiple separate redundant pluralities of IR transmission LEDs operable to concurrently wirelessly transmit said multiplexed audio signals and commands from said IR microphone/controller; and
c. a control circuit closure responsive to a command from said at least one IR microphone/controller to close a circuit that is not within said at least one IR microphone/controller.

17. The presentation audio system of claim 16, comprising a plurality of devices for assisting in operating said at least one IR microphone/controller while attached to one of the person of and the clothing of a user, said plurality of devices comprising;
a. an ergonomically shaped housing enabling hand-held operation of said at least one IR microphone/controller as such;
b. a spring clip coupled to said housing operable to attach said at least one IR microphone/controller to clothing of a user, and a microphone jack in said housing operable to connect a headset microphone for operation of said IR microphone/controller as an IR transmitter;
c. a keyhole in said spring clip and a lanyard for wearing about the neck of a user for supporting said at least one IR microphone/controller for operation as such, said lanyard comprising a spring-tensioned adjustment mechanism coupled to a key operable to couple said lanyard to said keyhole.

18. The presentation audio system of claim 1, wherein said at least one IR microphone controller is capable of operation in one of a first mode and a second mode, wherein:
a. said first mode enables volume control of a particular IR microphone/controller that is operated in said first mode when said particular IR microphone/controller is operated in said first mode; and
b. said second mode enables volume control of the entire said audio presentation system from said particular IR microphone/controller when said particular IR microphone/controller is operated in said second mode.

19. A presentation audio system comprising:
a. at least one IR microphone/controller wherein said IR microphone of said at least one IR microphone/controller is operable to transduce sound into audio signals and said IR controller of said at least one IR microphone/controller is operable to transduce manual control manipulations into commands, wherein said audio signals and said commands are multiplexed for wireless IR transmission from said at least one IR microphone/controller;
b. multiple separate redundant pluralities of IR transmission LEDs operable to concurrently transmit said multiplexed audio signals and commands from said IR microphone/controller;
c. a control circuit closure responsive to a command from said at least one IR microphone/controller to close a circuit that is not within said at least one IR microphone/controller;
d. a plurality of devices for assisting in operating said at least one IR microphone/controller while attached to one of the person of and the clothing of a user, said plurality of devices comprising:
i. an ergonomically shaped housing for hand-held operation of said at least one IR microphone/controller as such;
ii. a spring clip rotationally coupled to said housing and biased to a closed position, for attachment to clothing of a user, and a microphone jack in said housing for connecting a headset microphone for operation of said IR microphone/controller as an IR transmitter;
iii. a keyhole in said spring clip and a lanyard for wearing about the neck of a user for supporting said at least one IR microphone/controller for operation as such, comprising a spring-tensioned adjustment mechanism on said lanyard coupled to a key for coupling said lanyard to said keyhole;
e. wherein said at least one IR microphone controller is capable of operation in either of first and second modes, wherein:
i. said first mode enables volume control of the particular IR microphone/controller that is in said first mode; and
ii. said second mode enables volume control of the entire said audio presentation system.

20. The presentation audio system of claim 19, comprising:
a. a plurality of IR sensors operable to receive said multiplexed IR signals from said at least one IR microphone/controller and to demultiplex said multiplexed IR signals into electronic audio signals and into electronic commands, respectively;
b. an amplifier, operable to receive said electronic audio signals and said electronic commands from said plurality of IR sensors and further operable to:
i. house and operate, responsive to said received electronic commands, said control circuit closure;
ii. control amplification responsive to said received electronic commands;
iii. receive said electronic audio signals from a plurality of additional audio sources;
iv. supply amplified audio signals to at least one audio speaker;
v. control amplification responsive to said received electronic commands;
vi. receive said electronic audio signals from a plurality of additional audio sources;
vii. supply amplified audio signals to at least one audio speaker;
viii. be installed on an appliance support pole; and
ix. be installed on an industry-standard electronics rack; and
c. at least one audio speaker operable to receive said amplified audio signals from said amplifier.
